(19) United States
(12) Patent Application Publication
(10) Pub. No.: US 2025/0083141 A1
(43) Pub. Date: Mar. 13, 2025

(54) VAT PHOTOPOLYMERIZATION 3D PRINTING METHOD AND APPARATUS

(71) Applicant: University of Southern California, Los Angeles, CA (US)

(72) Inventors: Yong Chen, La Canada, CA (US); Huachao Mao, West Lafayette, IN (US); Yang Xu, Los Angeles, CA (US)

(73) Assignee: University of Southern California, Los Angeles, CA (US)

(21) Appl. No.: 18/294,990

(22) PCT Filed: Aug. 3, 2022
(86) PCT No.: PCT/US2022/039343

§ 371 Date: Feb. 2, 2024

Related U.S. Application Data
(60) Provisional application No. 63/228,936, filed on Aug. 3, 2021.

(51) Int. Cl. B01L 3/00; B29C 64/129; B29C 64/245; B29C 64/286; B29L 22/00; B33Y 10/00; B33Y 30/00; B33Y 80/00

(52) U.S. Cl. CPC B01L 3/502707; B29C 64/129; B29C 64/245; B29C 64/286; B33Y 10/00; B33Y 30/00; B01L 2200/0652; B01L 2300/0681; B29L 2022/007; B33Y 80/00

(57) ABSTRACT

Systems and methods are disclosed for a 3D microfluidic channel manufacturing device comprising: a main build platform and an auxiliary build platform, for printing microfluidic channels in a 3D printed product.

### PRIORITY CLAIM

This application claims priority to U.S. provisional patent application No. 63/228,936, titled “VAT PHOTOPOLYMERIZATION 3D PRINTING METHOD AND APPARATUS”, filed Aug. 3, 2021. The '936 disclosure is incorporated here by reference in its entirety for all purposes.

### STATEMENT AS TO FEDERALLY SPONSORED RESEARCH

This invention was made with government support under contract number CMMI-1663663 awarded by the National Science Foundation (NSF). The government has certain rights in this invention.

### FIELD

Disclosed herein are methods, apparatus, and/or systems for vat photopolymerization 3D printing that enables construction of miniaturized devices, e.g., microfluidic devices or the like, having features such as hollow channels that are truly micrometer-sized for use in desired end-use applications such as in chemistry and biomedical fields.

### BACKGROUND

Miniaturized devices such as microfluidic chips are intrinsically a set of connected microchannels or chambers within a bulk material with inlets and outlets. A liquid fluid is directed, mixed, or split by microchannels' network to achieve the desired applications in chemistry and biomedical fields such as microreactors, fluid mixer, cell analysis/culture, drug assays, and cell/particle sorting. The miniaturized microfluidic devices allow for high-throughput and fully automatic processing with reduced sample and reagent consumption. Typically, for truly microfluidic devices, at least one channel dimension should be in the range of from 10 to 100 μm (which is also the size range of cells). Also transparency is always desired for easy visualization in this application domain (e.g., when working with fluorescently labeled samples).

Most microfluidic devices have been built with Polydimethylsiloxane (PDMS) by soft lithography, a technique based on PDMS micro-molding. However, soft lithography is time-consuming, and the whole process involves substantial human operations. Furthermore, the layered molding method limits the structural complexity of the microchannels that can be produced. In addition, aligning and bonding multiple PDMS layers to achieve advanced functions is hugely challenging. Finally, the high cost of instrumentation and cleanroom required for soft lithography also hampered microfluidic devices to a broader audience. 3D printing has also been used to fabricate microfluidic chips, which has shown to be an improvement over the molding method described above. However, the use of 3D printing by conventional vat photopolymerization process to form microfluidic chips also has its limitations has limitations relating to resolution, thereby limiting the fabrication of channels to those having channel heights greater than 200 μm height at best, which limitation results from irradiation over-curing when forming the channel.

It is, therefore, desired that a 3D printing apparatus and method be developed in a manner that will enable constructing miniaturized devices, such as microfluidic devices or the like, having micro-scaled features such as transparent channels or the like having a feature dimension such as channel height or the like sized 100 μm or less.

### SUMMARY OF THE INVENTION

In an example embodiment, a method for constructing a device comprising a hollow channel by 3D printing process is disclosed. The method comprising the steps of: subjecting a selective region of a volume of a photopolymer resin disposed in a vat and along a transparent bottom surface of the vat to a radiation source, wherein the selective region of resin is interposed between the transparent bottom surface and a movable main build platform that is disposed in the vat; moving the main build platform vertically upward and away from the transparent bottom surface during the step of subjecting to initially construct a floor of a channel and subsequently construct opposed vertical wall sections of the channel extending from the floor, then stopping the step of subjecting, and moving the main build platform and attached channel floor and channel side walls vertically upward and away from the transparent bottom surface; moving an auxiliary build platform disposed in the vat to a position adjacent the transparent bottom surface, and subjecting a selected region of the volume of photopolymer resin interposed between the auxiliary build platform and the transparent bottom surface to the radiation source to construct a roof section of the channel, then stopping the step of subjecting and moving the auxiliary build platform away from the roof section that remains on the transparent bottom surface; and moving the channel floor and channel side walls, which are attached to the main build platform, over and adjacent to the roof section so that the channel side walls that are attached to the main build platform are aligned with the roof section, and subjecting a selective region of the volume of the photopolymer resin to the radiation source to cure the photopolymer resin between the roof section and the channel side walls to thereby bond the channel side walls and roof together to form the hollow channel, wherein the hollow channel has a width as defined along an x-axis between the opposed channel side walls and a height as defined along a z-axis between the floor and roof.

In another example embodiment, disclosed is a 3D microfluidic channel manufacturing device comprising: a main build platform and an auxiliary build platform, for printing microfluidic channels in a 3D printed product.

In another example embodiment, disclosed is a 3D printing apparatus for constructing a device comprising: a vat that accommodates a volume of photopolymer resin therein, the vat having a transparent bottom surface; a radiation source positioned to direct radiation through the transparent bottom surface of the vat and into the vat; a main build platform configured to move vertically in the vat upwardly and downwardly relative to the transparent bottom surface; an auxiliary build platform configured to move vertically and horizontally in the vat; and a controller for controlling movement of the main build platform, movement of the auxiliary build platform, and operating the radiation source for constructing a device by the 3D printing apparatus.

In another example embodiment, disclosed is a 3D printed product comprising: a first portion printed at a first time, a second portion printed at a second time, and a third portion printed at a third time, wherein the first time precedes the second time, which precedes the third time, but wherein the third portion is at least partially interposed between the first and second portions.

In another example embodiment, disclosed is a method of printing a 3D printed product comprising printing a first layer of the product and printing a second layer of the product that for a time is not attached to the first layer of the product, then bringing the first layer and the second layer in proximity to each other and printing a portion of the product that binds the first layer and the second layer together.

In another example embodiment, disclosed is a 3D printed microparticle sorting device created through use of a main build platform and an auxiliary build platform, the microparticle sorting device comprising: a mixed particle input port for receiving a stream containing particles of different sizes; an inlet channel; a first microchannel particle filter, the first microchannel particle filter comprising a first microchannel that is smaller than the inlet channel for blocking particles that will not fit through the first microchannel; a second microchannel particle filter, the second microchannel particle filter comprising a second microchannel that is smaller than the first microchannel for blocking particles that will not fit through the second microchannel; a flow through output port for providing flow through the first microchannel and the second microchannel in series; and a first sorted outlet port and second sorted outlet port corresponding respectively to the first microchannel particle filter and the second microchannel particle filter, for outputting particles sorted by size.

### BRIEF DESCRIPTION OF DRAWINGS

These and other features, aspects and advantages of the present invention will become better understood with reference to the following description, appending claims, and accompanying drawings where:

FIG. 1A illustrates a block diagram example 3D printing apparatus;

FIG. 1B illustrates an example physical embodiment of a 3D printing apparatus;

FIGS. 1C-1F illustrate perspective, top, front and side views of an example 3D printing apparatus having multiple vats and multiple auxiliary platforms;

FIGS. 1G-1H illustrate example build steps for a system comprising more than one tank or vat;

FIGS. 2A-2F illustrate an example 3D printing apparatus in operation in accordance with various example embodiments;

FIGS. 3A-3F illustrate another example 3D printing apparatus in operation in accordance with various example embodiments;

FIG. 4 is a flow diagram illustrating an example mask algorithm;

FIG. 5 is another example 3D printing apparatus in operation in accordance with various example embodiments;

FIG. 6 is an example microfluidic channel 3D printed product;

FIGS. 7A and 7B is a block diagram illustrating an example method of 3D printing; and

FIGS. 8A-8C is an example microfluidic sorting device, in accordance with various example embodiments.

### DETAILED DESCRIPTION

Disclosed herein is a vat photopolymer (VPP) 3D printing apparatus that may be referred to as performing In-Situ-Transfer VPP. The VPP 3D printing apparatus is configured to reliably produce miniaturized devices, e.g., such as microfluidic devices, with hollow channels having a channel of 100 μm or less, from about 10 to 100 μm, and for some applications of 10 μm or less. In an example embodiment, the VPP 3D printing apparatus can make such microfluidic devices in a manner that does not compromise transparency, e.g., when the desired device is to be transparent. In an example, the VPP 3D printing apparatus as disclosed herein avoids the need for customized light engines and photocurable or photopolymer resins with much lower light penetration depth, and uses a 405 nm light source and commercial photopolymer resin, e.g., transparent photopolymer resin, with a light penetration depth of approximately 179.1 μm.

The VPP 3D printing apparatus and method as disclosed herein avoids the light penetration limit on the minimum channel height, making more material options available for miniaturized device fabrication. In an example, a feature of the VPP 3D printing apparatus and method is the ability to print or construct the channel roof layer separately via double exposure with different print platforms, respectively. In an example embodiment, an auxiliary print or auxiliary build platform is utilized to print a channel roof (i.e., the top portion that encloses the channel) to block the delivery of light dose into the residual liquid resin inside the channel. The auxiliary build platform also works as a constrained surface to ensure the accuracy and surface finish of the channel. The channel roof is then in-situ transferred to the already built part (that comprises the channel floor and channel walls) with the second exposure of a mask image. The part comprising the channel floor and channel walls (the bulk part) is attached to a main build platform separate from the auxiliary build platform. According to this approach, channels having channel heights as described above may be achieved by controlling the roof thickness and the layer thickness of the subsequent layers.

In an example, an algorithm for generating corresponding mask images is also provided. The VPP 3D printing apparatus and method as disclosed herein is efficient and versatile, and such has been verified by fabricating multi-functional devices, including 3D microfluidic channels, microfluidic valves, and particle sorting devices. The results demonstrate that the VPP 3D printing apparatus and method is universal and can be applied to commercially available transparent resins, which operates to significantly broaden the range of available materials and challenge the dominant position of traditional manufacturing methods in the microfluidic fabrication domain, such as soft lithography.

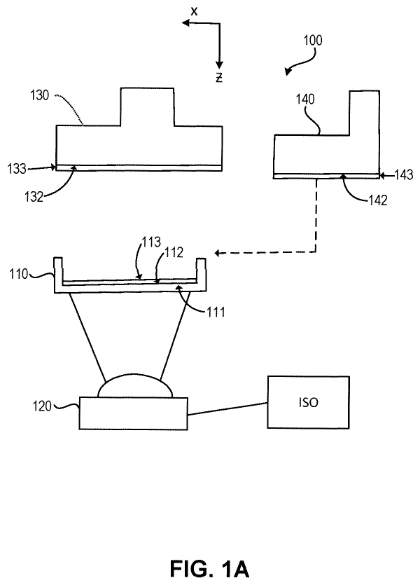

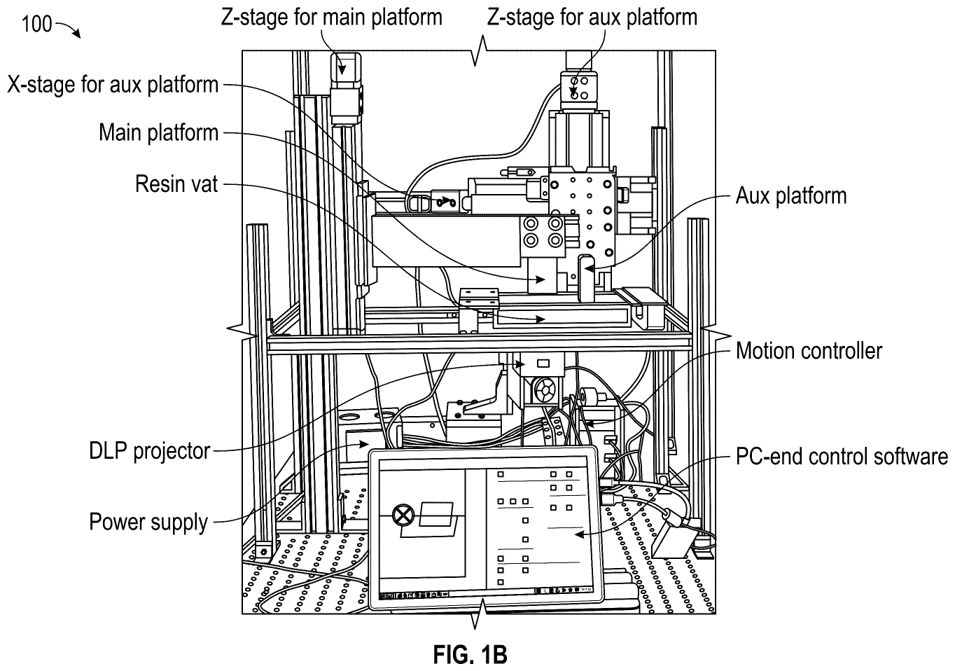

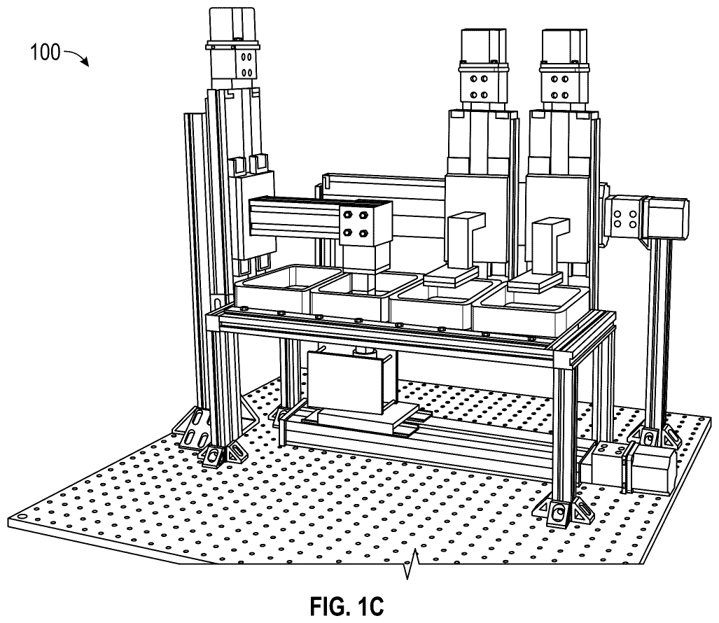

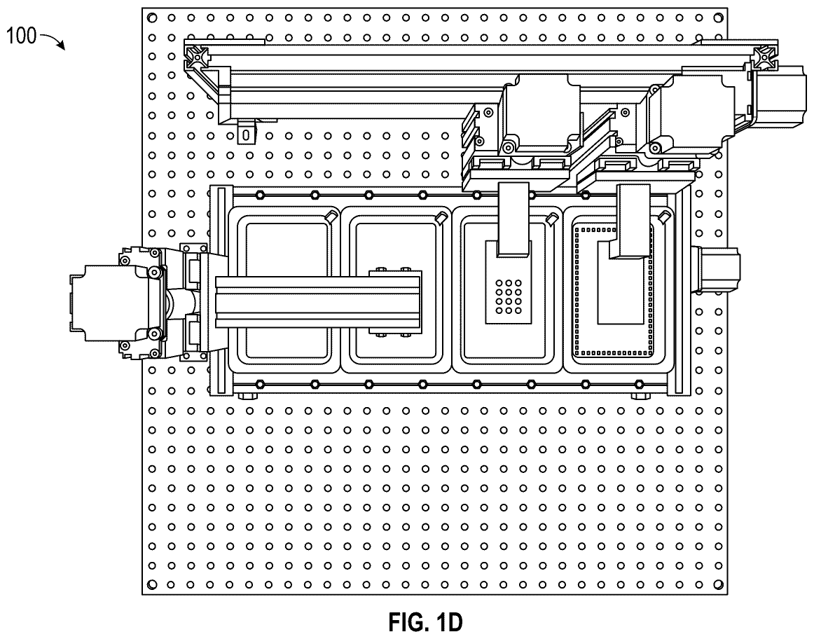

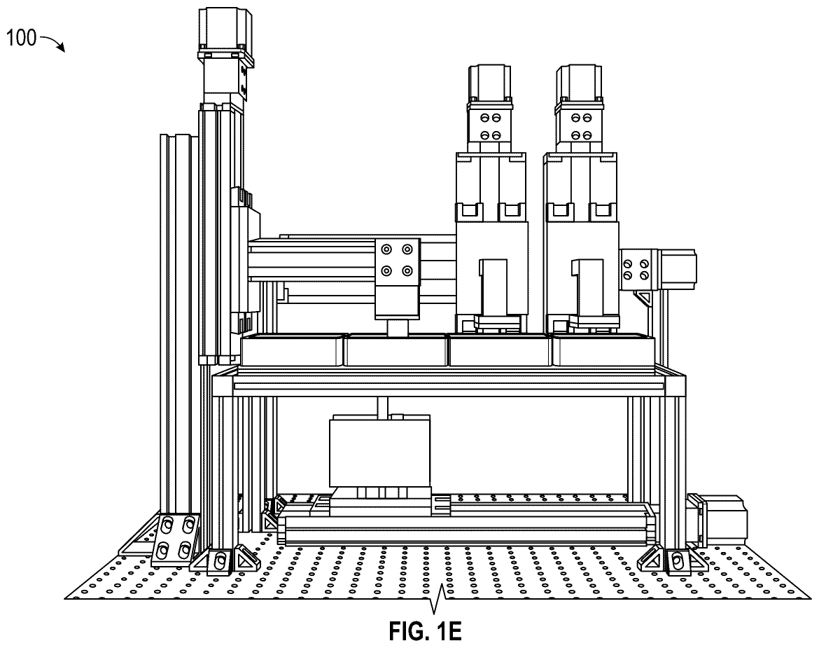

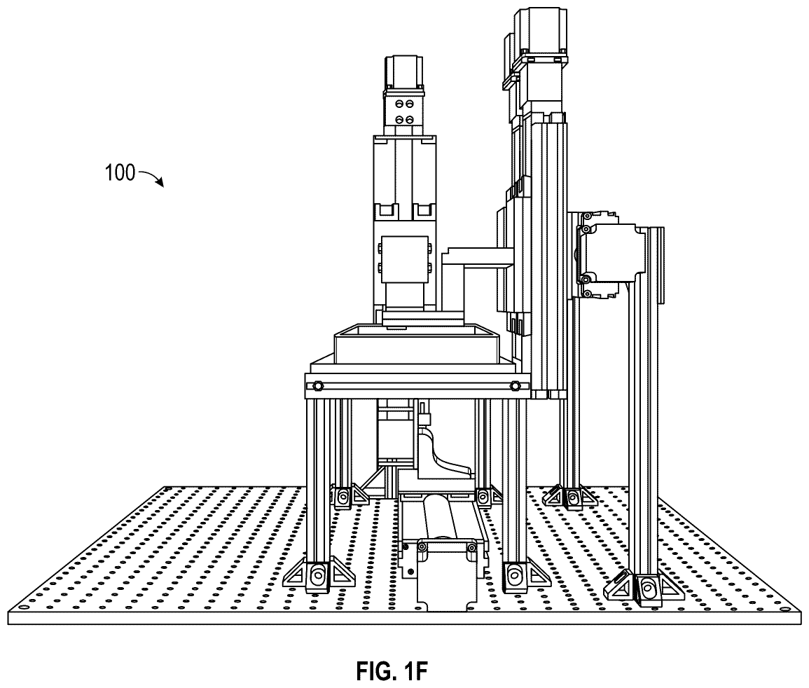

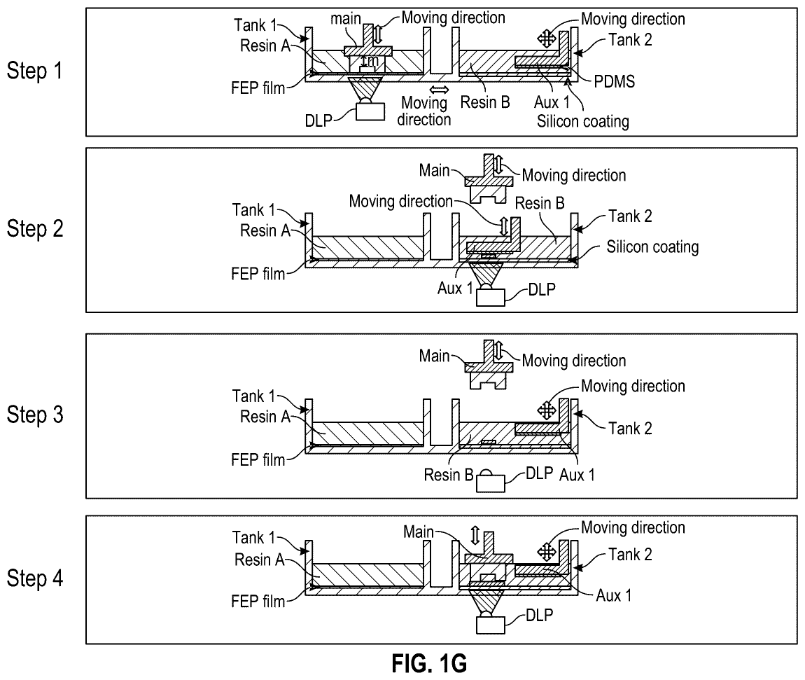

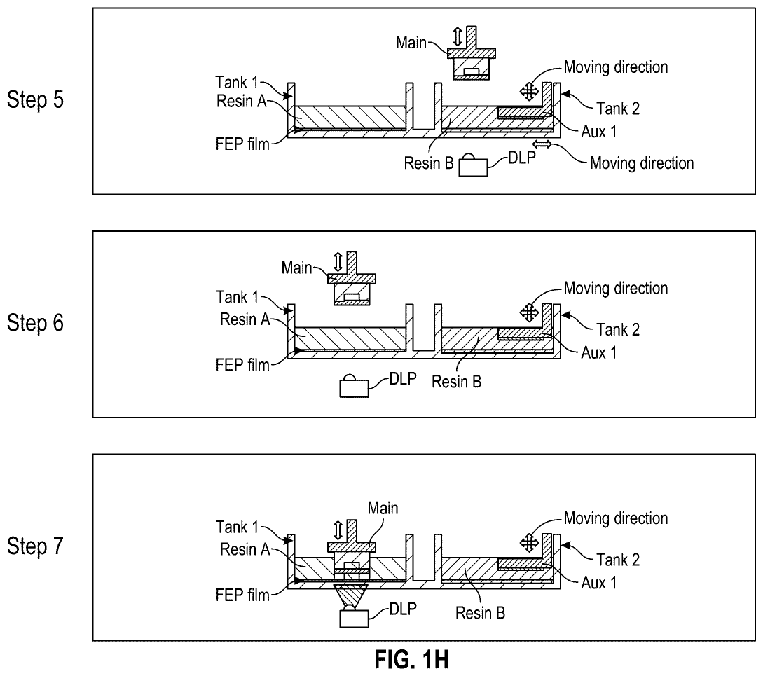

With reference now to FIG. 1, a 3D printing apparatus 100 is disclosed for In-situ-Transfer vat photopolymerization (IsT-VPP). FIG. 1 illustrates the 3D printing apparatus 100 from a side view perspective, in a block diagram form, for showing the relative locations, interaction, and functions of the various components. In an example embodiment, the 3D printing apparatus 100 comprises: a vat 110, a radiation source 120, a main build platform 130, and an auxiliary build platform 140. In an example embodiment, the 3D printing apparatus further comprises a controller 150. The main build platform 130, and the auxiliary build platform 140 may each be configured to move relative to the vat 110, and the auxiliary build platform 140 may move relative to the main build platform, as described further below. In an example embodiment, the 3D printing apparatus 100 is configured for 3D printing of microfluidic devices.

In an example embodiment, the vat 110 is configured to accommodate a volume of photopolymer resin therein. For example, the vat 110 may comprise a photopolymer resin that can be photocured using digital light processing (DLP), liquid crystal display (LCD), and/or laser, or a mixture of resin with fillers such as ceramics powders, metal powders, and ceramic or carbon fibers, etc. Moreover, any suitable 3D printing resin may be used. In an example embodiment, the vat 110 may comprise a vat bottom portion 111. In an example embodiment, the vat may be made of any suitable material. In one example embodiment, the vat bottom portion 11 comprises a transparent bottom surface. For example, the vat bottom portion 111 may be made of transparent glass or acrylic. Moreover, the vat bottom portion 111 may be configured in any suitable way that permits the radiation source 120 to irradiate portions of the resin in vat 110 for curing the resin.

In an example embodiment, the vat bottom portion 111 may have a vat surface 112 facing the inner portion of vat 110. In an example embodiment, the vat surface 112 has attached to it a thin film 113. For example, the thin film 113 may comprise a fluorinated ethylene propylene (FEP) film. In another example embodiment, the vat surface 112 is coated with a vat surface coating 113. For example, the vat surface coating 113 may comprise a Teflon coating. In an example embodiment, the vat surface coating 113 is transparent for permitting irradiation of the resin from the light source. Moreover, any suitable material may be used as the vat surface coating material to the extent it conforms to the relative bonding force rule described herein.

In an example embodiment, the main platform may be made of aluminum or glass. Moreover any suitable materials may be used to form the main build platform130. In an example embodiment, main build platform 130 comprises a main platform surface 132. The main platform surface may be a planar surface. In an example embodiment, the main platform surface 132 may be coated with a main platform coating 133. In one example embodiment, the main platform coating 133 is a base layer cured on the main platform surface 132 using a photopolymer resin. Moreover, the main platform coating 133 may be any suitable material conforming to the relative bonding force rule described herein. The main platform coating may be configured to pull a 3D printed part from the vat 110, as it is being printed, layer upon layer. The main platform may be configured to move vertically in the vat upwardly and downwardly relative to the transparent bottom surface.

In an example embodiment, the auxiliary build platform 140 comprises aluminum or acrylic. Moreover, any suitable materials may be used to form the auxiliary build platform 140. In an example embodiment, the auxiliary build platform 140 comprises an auxiliary platform surface 142. The auxiliary platform surface 142 may be a planar surface for forming a top portion of the 3D printed product. In an example embodiment, the auxiliary build platform 140 is configured to move both vertically and horizontally for insertion between the main build platform and the vat 110, and for 3D printing atop portion of the 3D printed product.

In an example embodiment, the auxiliary build platform may be driven vertically and horizontally, by respective linear actuators/motors. Moreover any suitable mechanism may be used to move the auxiliary build platform.

In an example embodiment, the auxiliary build platform is configured to print the channel roof (the top portion that encloses the channel), and to block the delivery of light into the channel. The auxiliary build platform provides a constrained surface to ensure the accuracy and surface finish of the roof of the channel.

In an example embodiment, the auxiliary platform surface 142 may be coated with polydimethylsiloxane (PDMS). Moreover, the auxiliary platform surface 142 may be coated with any suitable material conforming to the relative bonding force rule described herein.

In an example embodiment, the auxiliary platform may be hollow and attach a polymethylpentene (TPX) film as its surface 142. Moreover, the film surface 142 may use any suitable material conforming to the relative bonding force rule described herein.

In an example embodiment, the bonding force between the auxiliary build platform and cured resin is smaller than that between the vat 110 and the cured resin. Stated another way, the channel roof's bonding force is stronger with the vat 110 than with the auxiliary platform 140. In this manner, the channel roof, or top portion, of the full part can be left attached to the vat 110 when the auxiliary build platform 140 is withdrawn back to its inactive position. Moreover, the bonding force between the main build platform 130 and the cured resin is stronger than that between the vat 110 and the cured resin. In this manner, the bottom portion of the part can be pulled away from the vat 110, while the top portion is printed, and the completed part (top and bottom portions integrated together) can be pulled away from the vat 110 as each layer is added, and when completed.

In an example embodiment, the systems and methods disclosed herein use at least one of three techniques to cause the relative bonding forces described herein. First, the respective surfaces are coated with materials that provide the relative differences in bonding forces. For example, the vat surface 112 may be coated with and use a FEP film, while the auxiliary platform surface 142 is coated with PDMS, and the main platform surface 132 is aluminum or glass or coated with a base layer using photopolymer resin. Thus, the system and methods comprise selecting the vat, main and auxiliary surface coatings such that a more significant force is needed to break the vat interface (e.g., polymer-FEP film interface) than the auxiliary platform interface (e.g. Polymer-PDMS interface), given the same contact area. And such that a more significant force is needed to break the main platform interface (e.g. aluminum or glass or coated with a base layer interface) than the vat interface (e.g., polymer-FEP film interface), assuming the same contact area.

Second, the system and methods comprise designing the relative roof-vat vs. roof-aux vs. part-main contact areas such that the contact area of the roof with the auxiliary platform is smaller than the contact area of the roof with the vat, and the contact area of the roof with the vat is smaller than the contact area of the part to the main platform. This further helps intensify the bonding force difference because the bonding force increases with the contact area's increase for both coating media.

Third, the system and methods are configured such that the roof bottom receives more energy than the roof top when printing the roof. This occurs by causing the radiation source to be closer to the portion attached to the vat than to the portion attached to the auxiliary platform. In this manner, the adhesive bonding strength between the part and the coating media will be greater for the bond that has received more exposure to energy from the radiation source, and thus, the adhesion between the roof and the vat 110 will be stronger than the adhesion between the roof and the auxiliary platform.

In another example embodiment, and with momentary reference to FIGS. 1C-1F, the system and methods may comprise multiple auxiliary platforms. In this example embodiment, each auxiliary platform may have its own auxiliary platform surface and be coated with its own coating. In an example embodiment, the adhesion force between the auxiliary platforms may vary in any suitable manner that would facilitate the desired 3D printing process. For example, the embodiment shown in FIGS. 1C-1F (showing perspective, top, front and side views) comprise, in addition to a main platform and a resin tank, three additional resin tanks (with different resins) and two auxiliary platforms, which can be used in the in-situ transfer vat photopolymerization. In an example embodiment, the main platform is made of aluminum surface, one resin tank uses a FEP film, another resin tank is a glass coated with a silicone layer, and the third resin tank is a glass coated with a PDMS layer. The fourth resin tank is a glass without coating and will be used to collect residual resin only. One auxiliary platform surface is a glass coated with a PDMS layer and another auxiliary platform surface is a TPX film. Their relative adhesion forces are TPX film<PDMS layer<FEP film<Silicon layer<aluminum. The multiple auxiliary platforms may each be configured to be moved into position with the vat that has a bigger adhesion force, in their turn, and finally between the main build platform that has the largest adhesion force.

In another example embodiment, the system and methods could further comprise more than one vat, each vat similar to that described herein. In these example embodiments, each vat may comprise a different resin material or a mixture of resin and different fillers such as microscopic particles and fibers.

With reference now to FIG. 1G-1H, which illustrate an example process using two vats or tanks, one example of building parts consisting of two materials is shown that is built using two tanks (Tank 1 and 2) and one auxiliary platform (Aux 1). In Step 1, a set of layers are built using Resin A in Tank 1. Afterwards, the main platform is moved up out of the Tank 1. The two tanks are mounted together with the Aux1 platform and moved in the sideway direction using a linear stage. Afterwards, in Step 2, the Aux 1 platform is moved down to cure a portion of a channel roof layer using Resin B. In Step 3, the Aux1 platform is moved up and also sideways. The coating of Aux 1 has an attaching force that is smaller than the one related to the coating of Tank 2; hence the cured layer is attached to the bottom of the resin tank 2. In Step 4, the main platform is moved down to form a gap with the bottom surface of Tank 2. Afterwards, the other portion of the roof layer is cured and bonded with the previous layers in the main platform. In Step 5, all the cured layers including the roof layer are moved from the bottom surface of Tank 2 since the bonding force of the main platform is larger than that related to the coated surface of Tank 2. In Step 6, both tanks and Aux 1 are moved in the sideways direction so Tank 1 is moved back under the main platform. In Step 7, additional layers using Resin A can be continuously built in Tank 1. The process can repeat as often as desired.

In an example embodiment, the radiation source is a light source. For example, the radiation source may be a digital light processing (DLP) projector, or a liquid crystal display (LCD), or a scanning laser beam. The radiation source is configured to cure at least portions of a liquid resin contained in the vat 110. The radiation source is positioned relative to the vat 110, and/or the main build platform 130/auxiliary platform 140, so as to direct radiation, through the transparent vat bottom portion 111 and vat surface coating 113, into a liquid resin contained in the vat 110. In an example embodiment, the radiation source 120 is configured to cure at least portions of the liquid resin in a layer located between a build platform surface and the vat surface coating. In an example embodiment, the light source 120 is configured to provide a light that penetrates a predetermined light penetration range of depths. In an example embodiment, the light may be configured to penetrate from 20 μm-500 μm, or in another example from 100 μm to 300 μm. Moreover, any suitable light penetration depth may be selected. The light penetration depth may be a factor of the wavelength of the light, its intensity, the exposure time, and the vat bottom portion material, the vat surface coating, and/or the resin material selected. In an example embodiment, the radiation source is a 405 nm light source, and the resin is a commercial transparent resin with a light penetration depth of 179.1 μm.

In an example embodiment, the radiation source 120 is configured to receive software generated mask images configured to cause specific areas of the resin in the vat to be cured and other areas to not be cured corresponding to the mask images projected into the vat.

In an example embodiment, the controller 150 is configured to control movement of the main build platform, movement of the auxiliary build platform, and operation of the radiation source for constructing a device by the 3D printing apparatus. The controller may comprise any suitable device for providing commands to the motive force devices for moving the auxiliary build platform and main build platform, respectively. The device may further provide commands to the radiation source. For example, providing the desired mask image, and/or any instructions on how long to expose the resin to the radiation/light, the intensity of the light, and or the like. The controller may be in one location, at the location of the system 100, or remote therefrom, and/or may be one integrated controller or one or more separate controllers working together to provide the described control.

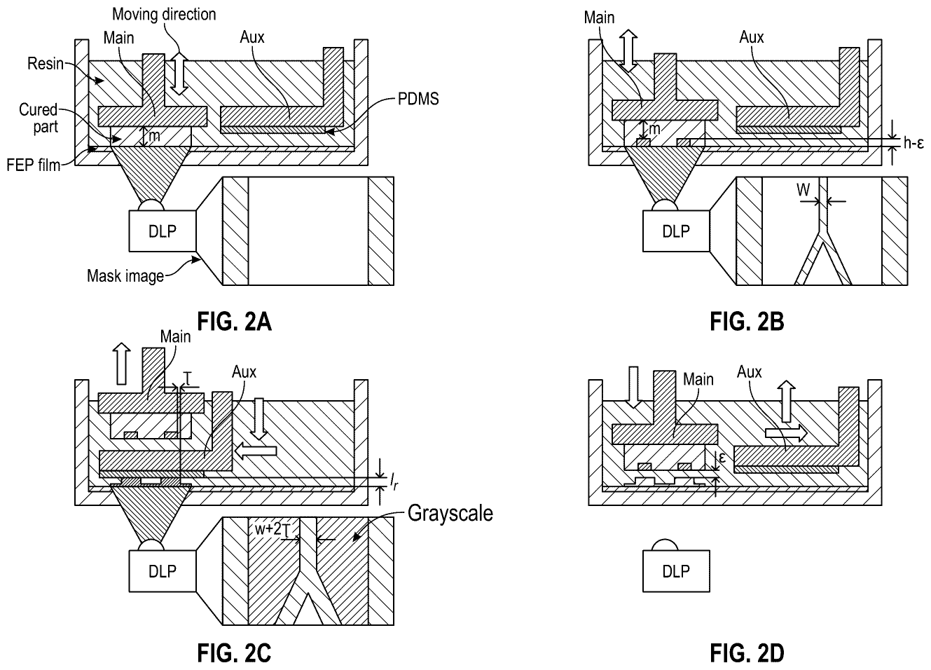

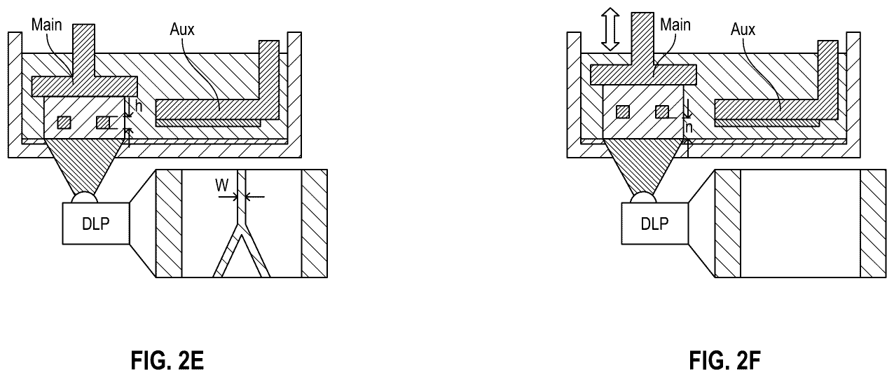

In an example embodiment, and with reference now to FIGS. 2A-2F, the system 100 is configured to first use main build platform 130 and cure a first block comprising one or more solid layers cured by curing a layer attached to the main build platform 130 and moving the platform in the negative Z direction to create a cured block that is one or more cured layers thick.

Next a mask may be used to add layers to the first block that have noncured portions where the micro-channels (features) are to exist. These channel containing layers are also fabricated using the main platform with continued steps in the Z direction.

To build the roof of the channels, the main platform is now withdrawn in the negative Z direction, and the auxiliary build platform 140 is brought down and over to be situated between the already printed portion (the bottom portion) and the vat 110. In an example embodiment, the auxiliary build platform 140 is positioned to form a small gap between the auxiliary surface 141 and the vat 110. The gap may be for example 120 μm thick. The channel roof portion can now be formed on the surface of the auxiliary build platform 140. The channel roof portion may have a width slightly wider than the channel width w. In this example embodiment, the auxiliary platform surface 141 constrains the top surface of the channel roof, thus providing channel accuracy ad surface quality. For the step of bonding the channel roof to the channel containing layers, in one example embodiment, the bonding is affected by semi-curing the resin using a lower grayscale level (50<grayscale levels<200). This has the effect of reducing the light intensity, so that portions of the resin corresponding to those grayscale pixels will not be fully cured. Instead, they will be partially cured with a smaller cure depth, facilitating making the attachment area and strength at the vat surface be larger than the attaching area and strength to the auxiliary build platform.

The auxiliary platform 140 can then move up in the negative Z direction releasing the top portion (full layer and channel cover layer) which remain attached to the vat 110. In this action, the roof's bonding force is more significant with the resin vat than with the auxiliary platform.

Next the auxiliary build platform 140 is extracted from between the bottom and top separate portions. This movement may also be referred to as moving the auxiliary platform 140 back to an idle position. After the auxiliary platform 140 is out of the way the main build platform is lowered in the positive Z direction to put the bottom portion in proximity to the top portion, with a controlled gap between the bottom portion and the top portion. A further cure process of the liquid resin in the gap bonds the top portion to the bottom portion.

The main build platform again moves in the negative Z direction and the whole part now releases from the vat 110 and remains attached to the main build platform 130. In an example embodiment, further main platform building can be performed at this point. Moreover, these steps can be repeated for multiple layers built in this fashion. In one example embodiment, the channel roof significantly reduces the light dose delivered into the channel when curing the additional layers at this point.

In an example embodiment, the polymer-glass interface's bonding force is much stronger than the polymer and FEP film interface. Therefore, the two previously separated parts will combine as one and attach firmly to the main platform during the release process. Moreover, the resins trapped inside the channel remain unpolymerized as they are not cured by the light source, and this unpolymerized fluid can be rinsed out at a later point in the process.

In an example embodiment, FIG. 1B illustrates an example physical embodiment of a 3D printing apparatus. The Z-stage driver motors for the main and auxiliary platforms is shown, as is the X-stage driver motor for the auxiliary platform. The main and auxiliary platforms are shown. The resin vat is shown, as is the DLP projector and motion controller and end control software run from a computer.

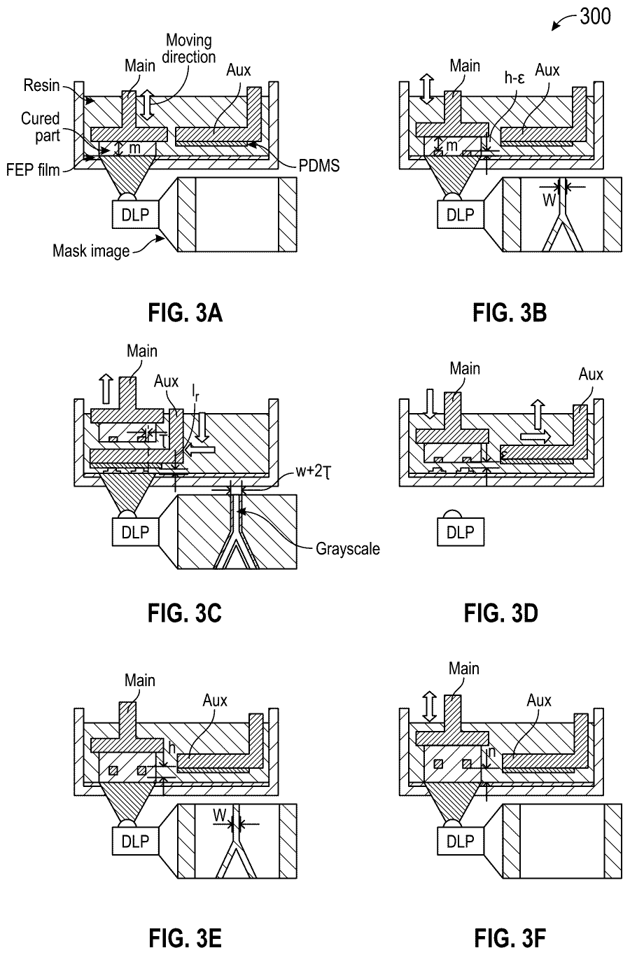

With reference now to FIGS. 3A-3F, in an example embodiment, a 3D printing system 100 is configured to 3D print a work having a normal layer thickness (e.g., 10 μm), a roof layer thickness lᵣ (e.g., 200 μm), a gap size F (e.g., 10 μm). Moreover, any suitable sizes and ranges can be used. In an example embodiment, the mask may be configured to have an outward offset τ (e.g., 4 pixels). The offset τ represents a margin around the channel edges, and in that margin, a gray scale is used to prevent exposing resin in the channel. Thus, as can be seen in FIGS. 3A-3F, a gray scale may be shown on the mask image for the bonding step (bonding the roof to the channel portion), to prevent exposing the resin in the channel.

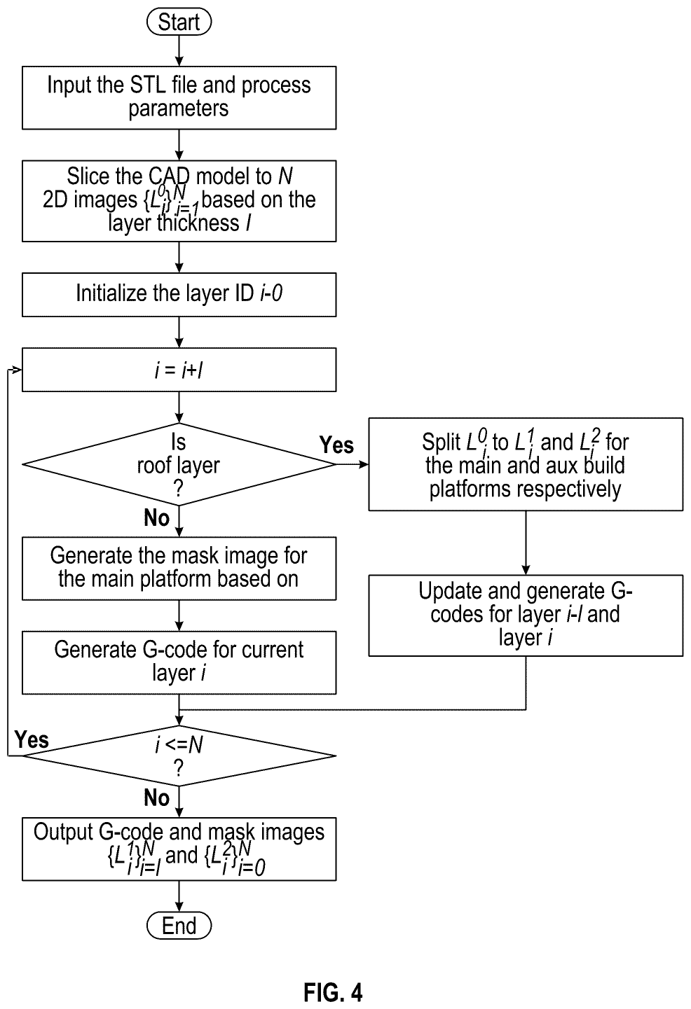

In an example embodiment, the system is configured to make the presented IsT-VPP universally applicable to general microfluidic applications, through use of an image planning algorithm to handle complex channel networks. With reference to FIG. 4, and the table below, an example mask image planning algorithm is disclosed.

First, the input 3D CAD model represented by a .stl file is sliced into N 2D images {Lᵢ⁰}ᵢ₌₁^{N} as a basis according to a given layer thickness l. Each 2D image is a matrix with the same dimension as the projector's pixel resolution (e.g., 1280×800). Each matrix element is an integer value, ranging from 0 to 255, representing the duty ratio of each microscopic mirror's on/off state in the digital micromirror device (DMD).

Second, the system is configured to calculate the critical value for the roof thickness lᵣ given a resin type in the analytical model section. The critical roof thickness lᵣ is further converted to a critical layer number k, the number of layers affected by current exposure with the highest grayscale level 255.

Third, for each layer containing a channel roof Lᵢ⁰, a mask image is created for the main build platform Lᵢ¹ and its counterpart Lᵢ² for printing the channel roof portion via the auxiliary platform. Both images are initialized Lᵢ⁰. The channel area is defined as Lᵢ⁰−Lᵢ₋₁⁰. The corresponding roof area is derived by offsetting the channel area outward with τ pixels. In the mask image Lᵢ², the grayscale level in the non-roof area is decreased by an energy reduction factor 0<α<1. In the mask image Lᵢ¹, which is used to connect the channel roof with the previously built part, the channel area is set to 0 to avoid the over-curing issue. For the void area within the previous k layers that may be affected by exposure Lᵢ¹, the grayscale level in such places is reduced by an energy reduction factor 0<β<1.

Finally, the system is configured to generate a G-code for the main and auxiliary build platforms. If the following k−1 layers are identical to the current roof layer, the system is configured to change the layer thickness to k×1, and update the layer index. Otherwise, the system will use the original layer thickness l. The G-code for the previous layer Lᵢ₋₁¹ may also be adjusted accordingly. If the channel height h is larger than the gap size ε, the system will change the Lᵢ₋₁¹ layer thickness to l−ε. Otherwise, the system will delete the layer Lᵢ₋₁¹ and skip step 2.

For non-roof layers, the system may initialize Lᵢ¹ with the original mask image Lᵢ⁰. Similarly, the void area of previous k layers in Lᵢ¹ will be modified. The G-code for non-roof layers may be generated as usual. In an example embodiment, the system may be implemented using in-house-developed software for slicing 3D models and contour offsetting^{1, 2}. In an example embodiment, these algorithms are realized in C++.

TABLE
General mask image planning algorithm for 3D printing microfluidic chips via IsT-VPP.

| Algorithm 1: | Generate mask images and G-code | | |
|---|---|---|---|
| Input: | 3D CAD model .stl, layer thickness l , critical roof thickness lᵣ , minimum gap ε , outward | | |
| | offset τ , and energy reduction factor α , β | | |
| Output: | Mask images Lᵢ¹ and Lᵢ² for the main and auxiliary build platforms of each layer i , G-code | | |
| 1 | {Lᵢ⁰}ᵢ₌₁^{N} ← sliceTo2D(.stl, l); | | |
| 2 | k ← ┌lᵣ / l┐; | | |
| 3 | for i ← 1 to N do | | |
| 4 | \| | if isRoof ( Lᵢ⁰ ) then | |
| 5 | \| | \| | Lᵢ¹ ← Lᵢ⁰; Lᵢ² ← Lᵢ⁰; |
| 6 | \| | \| | channelArea ← Lᵢ⁰ − Lᵢ₋₁⁰; |
| 7 | \| | \| | roofArea ← offset( channelArea, τ ); |
| 8 | \| | \| | Lᵢ²[ NOT roofArea] ← 200 × α ; |
| 9 | \| | \| | Lᵢ¹[channelArea] ← 0 ; |
| 10 | \| | \| | Lᵢ¹[Lᵢ₋₁⁰ == 0∪Lᵢ₋₂⁰ == 0∪...∪Lᵢ₋ₖ₋₁⁰ == 0] ← 255 × β ; |
| 11 | \| | \| | i ← updateGCode({Lᵢ⁰}ᵢ₌₁^{N}, i , l , lᵣ , ε , β ); |
| 12 | \| | else | |
| 13 | \| | \| | Lᵢ¹ ← Lᵢ⁰; |
| 14 | \| | \| | Lᵢ¹[Lᵢ₋₁⁰ == 0∪Lᵢ₋₂⁰ == 0∪...∪L_{i-k&minus1}⁰ == 0] ← 255 × β ; |
| 15 | \|_{—} | \|_{—} | generateGCode(i , l , roofLayer = false); |

| 16 | return {Lᵢ¹}ᵢ₌₁^{N}, {Lᵢ²}ᵢ₌₁^{N}, G-code; | |
|---|---|---|
| Algorithm 2: | Generate G-code for roof printing and modify G-code for the previous layer: updateGCode( | |
| | {Lᵢ⁰}ᵢ₌₁^{N}, i , l , lᵣ , ε , β ) | |
| Input: | Initial sliced 2D images {Lᵢ⁰}ᵢ₌₁^{N}, current layer index i , layer thickness l , roof thickness lᵣ , | |
| | minimum gap ε , and energy reduction factor β | |
| Output: | Next layer index i | |
| 1 | if channelHeight(i) > ε then | |
| 2 | \|_{—} | generateGCode (i − 1 , l − ε , roofLayer = false); |
| 3 | else | |
| 4 | \|_{—} | deleteLayer(i − 1 ); |
| 5 | k ← ┌lr / l┐; | |
| 6 | if Lᵢ⁰ == Lᵢ₊₁⁰ == ... == Lᵢ₊ₖ₋₁⁰ then | |
| 7 | \| | generateGCode (i , k × 1 , roofLayer = true); |
| 8 | \|_{—} | i ← i + k − 1 ; |
| 9 | else | |
| 10 | \|_{—} | generateGCode (i , l , roofLayer = true); |

| | |
|---|---|
| 11 | return i ; |

The presented IsT-VPP approach can be applied to commercial DLP/LCD resin 3D printers by extending the existing hardware and software systems. In an example embodiment, the hardware and software used may comprise: Hardware: Motorized linear stage x2, Microcontroller board, Stepper motor driver with two outputs, photoelectric limit switch, print platform; and Software: Printing file preparation software for DLP/LCD resin printers.

Additional two linear stages used to move the auxiliary build platform in both X and Z axes can be placed right beside the commercial resin 3D printer. An external microcontroller is used to monitor the signal from the photoelectric limit switch mounted on the top of the Z-stage. Once the main build platform hits the limit switch, the microcontroller drives the motorized linear stages to move the auxiliary build platform to form a layer thickness gap with the resin tank. After the first exposure for the roof layer, the auxiliary build platform returns to its home position. Then the Z stage moves the main build platform down to prepare for the second exposure. After the two exposures, the channel is successfully fabricated. The non-roof layers are manufactured via the normal printing process using only the main build platform. To coordinate the movement of each component, the printing file software system may be modified so the printing job file can be generated according to the presented IsT-VPP building process.

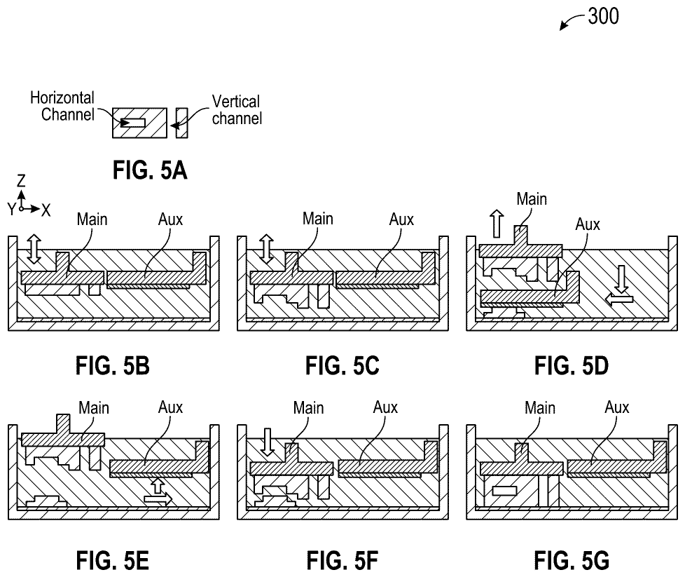

With momentary reference to FIG. 5, a 3D printing process that generates both vertical and horizontal channels is illustrated. In FIG. 5, the cross section (a) shows a cross section having horizontal and vertical channels. Views (b)-(g) show example fabrication steps for forming both horizontal and vertical channels. It is noted that the side walls of the vertical channel can be fabricated using the main platform only (see view (c)), but this can be done without being affected by the use of the auxiliary platform used for form the horizontal channel.

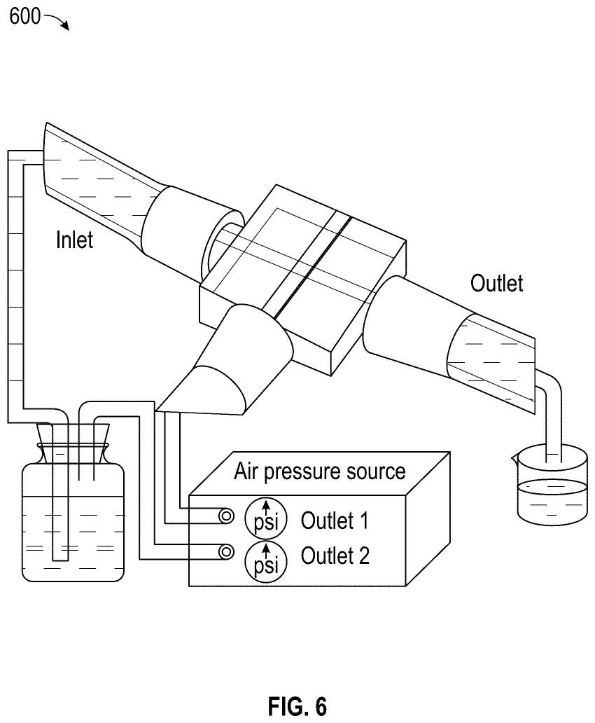

With brief reference to FIG. 6, in an example embodiment, the 3D printing apparatus 100 is configured to produce a unique device having micro-features within a bulk material. The micro features may be hollow features having a height of 10 μm or less. The unique device may be transparent. In an example embodiment, the 3D printed product is a microfluidic device. In an example embodiment, the device produced may comprises one or more microchannels or chambers within a bulk material with inlets and outlets. In an example embodiment, the microfluidic device is a microfluidic chip and comprises multiple microchannels. In an example embodiment, the microfluidic chip is configured to direct liquid fluid to flow through these channels, to be mixed or split in a microchannel network to achieve the desired applications in chemistry and biomedical fields and the like. In an example embodiment, the microfluidic device acts as a microreactor, fluid mixer, cell analysis/culture, drug assays, and/or cell/particle sorting. The microfluidic device may be configured for high-through put. The microfluidic device may be configured for fully automatic processing with reduced sample and reagent consumption. The microfluidic device may be configured such that at least one channel dimension is in the range of 10-100 μm (i.e., cell size), and less than 10 μm in some instances. The microfluidic device may be configured such that the bulk material is transparent providing desirable visualization (i.e., for fluorescently labeled samples).

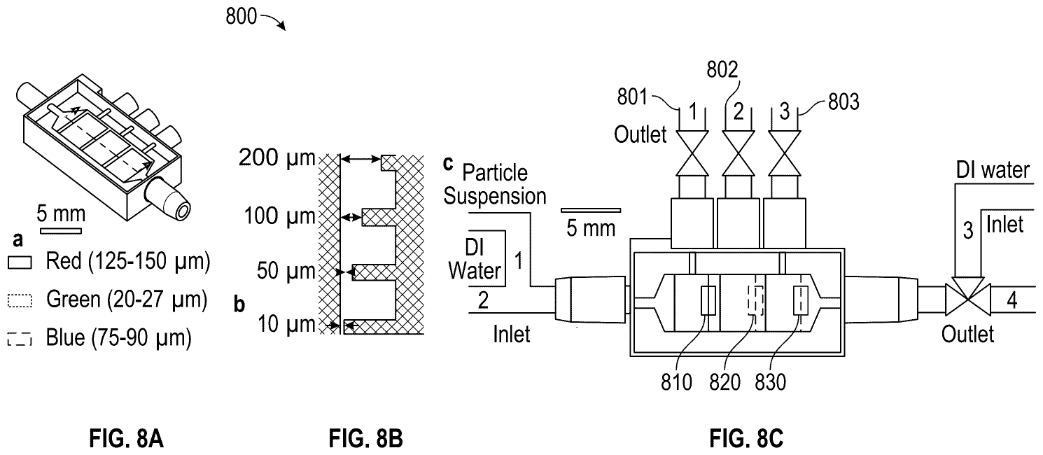

In an example application, the systems and methods disclosed herein may be used to create a micro-particle sorter, as mentioned above. With reference to FIGS. 8A-8C, an example micro-particle sorter 800 is illustrated. The particle sorter may comprise an inlet 1 for supplying a stream of mixed particles, a distilled water inlet 2 (transport medium), micro channel filters 810/820/830, a flow through outlet 4, and a distilled water inlet 3 for providing back flow through the microchannel filters. The particle sorter 800 may further comprise outlets 801, 802, 803 for particles of different sizes. The microparticle sorting device 800 may comprise an inlet channel sufficiently large to allow all particles to pass. The microparticle sorting device 800 comprises channels of different sizes, such that, in this example, a large particle is kept from passing through the first microchannel filter 810 because the particle is larger than that channel, but the other particle pass through; then the medium particles are kept from passing through the second microchannel filter 820 because the medium particle is larger than the associated channel; and finally, the small particles are kept from passing through the third microchannel filter 830 because the small particles are still larger than the associated channel. In this manner the particles in a mixed stream of particles are sorted and can be washed out through respective sorted particle outlets 801, 802, and 803. It should be understood that without the ability to create channels at these size ranges with very tight tolerances, such a sorter could not be 3D printed. Such a particle sorter could be used, for example, to sort out cancerous cells from healthy cells.

In contrast to typical microfluidic devices made with polydimethylsiloxane (PDMS) by soft lithography (a technique based on PDMS micro-molding, the microfluidic devices manufactured by the processes and devices disclosed herein are formed more quickly with fewer human operations. Moreover, the structural complexity achievable by the disclosed system and methods, can be much more complex, without aligning and bonding challenges. The microfluidic device, systems and methods disclosed herein may provide high resolution, smooth surface quality and less expensive manufacturing.

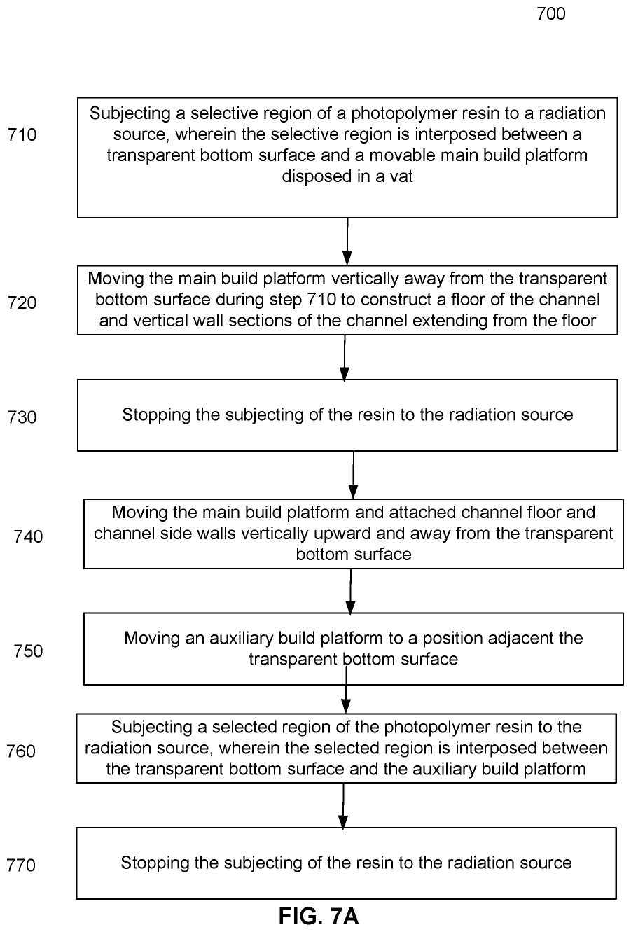

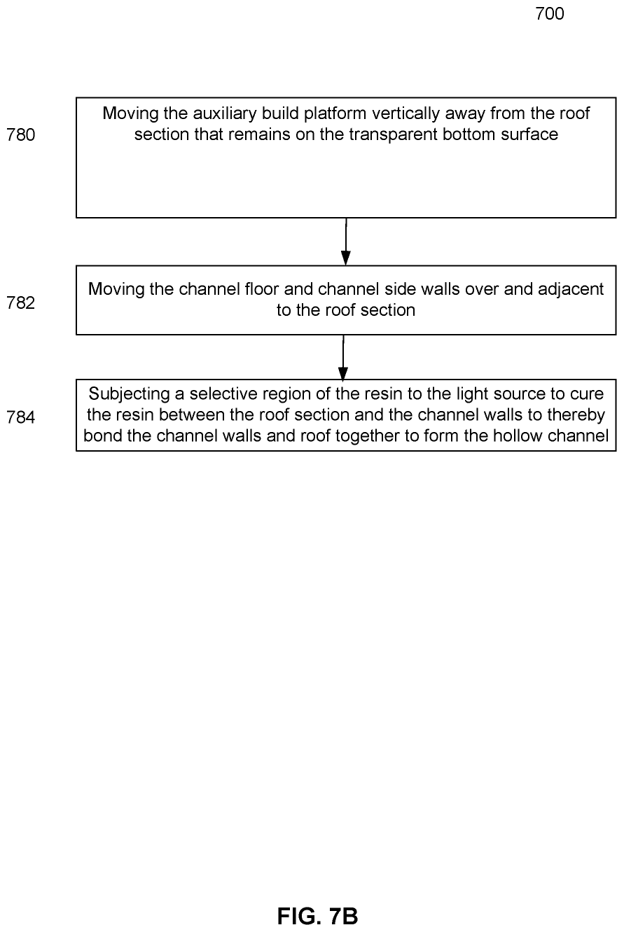

With reference now to FIG. 7, in an example embodiment, a method 700 is disclosed for constructing a device comprising a hollow channel by 3D printing process. In an example embodiment, the method 700 comprises: (710) subjecting a selective region of a volume of a photopolymer resin disposed in a vat and along a transparent bottom surface of the vat to a radiation source. In this example embodiment, the selective region of resin is interposed between the transparent bottom surface and a movable main build platform that is disposed in the vat.

The method 700 further comprises: (720) moving the main build platform vertically upward and away from the transparent bottom surface during the step of subjecting to initially construct a floor of the channel and subsequently construct opposed vertical wall sections of the channel extending from the floor, then (730) stopping the step of subjecting, and (740) moving the main build platform and attached channel floor and channel side walls vertically upward and away from the transparent bottom surface.

The method 700 further comprises: (750) moving an auxiliary build platform disposed in the vat to a position adjacent the transparent bottom surface, and (760) subjecting a selected region of the volume of photopolymer resin interposed between the auxiliary build platform and the transparent bottom surface to the radiation source to construct a roof section of the channel, then (770) stopping the step of subjecting and (780) moving the auxiliary build platform away from the roof section that remains on the transparent bottom surface.

The method 700 further comprises: (782) moving the channel floor and channel side walls, which are attached to the main build platform, over and adjacent to the roof section so that the channel wall sections that are attached to the main build platform are aligned with the roof section, and (784) subjecting a selective region of the volume of the photopolymer resin to the light source to cure the photopolymer resin between the roof section and the channel walls to thereby bond the channel walls and roof together to form the hollow channel, wherein the hollow channel has a width as defined along an x-axis between the opposed channel walls and a height as defined along a z-axis between the floor and roof.

In this method 700, the main build platform is configured to move vertically in the vat, and wherein the auxiliary build platform is configured to move horizontally and vertically in the vat. Moreover, in an example embodiment, during the step of moving the auxiliary build platform to the position adjacent the transparent bottom surface, the auxiliary build platform moves horizontally in the vat beneath the main build platform. In a further example embodiment, during the step of constructing the roof section, the auxiliary build platform is moved vertically away from the transparent bottom surface while the region of the photopolymer resin interposed therebetween is subjected to the radiation source. In an example embodiment, during the step of subjecting the region of the volume of photopolymer resin to construct the roof section, the auxiliary build platform blocks radiation from the radiation source from passing to the main build platform. In an example embodiment, during the step of subjecting the resin to the radiation to build the channel floor and/or wall sections, a mask image is used to pattern radiation passing from the radiation source to the transparent bottom surface and into the vat.

In accordance with an example embodiment, a 3D printed product comprises a first portion printed at a first time, a second portion printed at a second time, and a third portion printed at a third time, wherein the first time precedes the second time, which precedes the third time, but wherein the third portion is at least partially interposed between the first and second portions.

In another example embodiment, a 3D printed product is formed by printing at least one layer of the product and printing a second layer of the product that for a time is not attached to the product, then bringing the two layers in proximity and printing a portion of the product that binds the two layers together.

In an example embodiment, a 3D microfluidic channel manufacturing device comprises a main build platform and an auxiliary build platform, for printing microfluidic channels in a 3D printed product.

In an example embodiment, a 3D microfluidic channel manufacturing device comprises a main build platform and an auxiliary build platform, for printing products that have shapes that would not be suitable for continuous pull printing from a single main build platform. [can we define what we mean by “odd shapes” that don't work]

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted except in light of the appended claims and their equivalents.

1. A method for constructing a device comprising a hollow channel by 3D printing process, the method comprising the steps of:
subjecting a selective region of a volume of a photopolymer resin disposed in a vat and along a transparent bottom surface of the vat to a radiation source, wherein the selective region of resin is interposed between the transparent bottom surface and a movable main build platform that is disposed in the vat;
moving the main build platform vertically upward and away from the transparent bottom surface during the step of subjecting to initially construct a floor of a channel and subsequently construct opposed vertical wall sections of the channel extending from the floor, then stopping the step of subjecting, and moving the main build platform and attached channel floor and channel side walls vertically upward and away from the transparent bottom surface;
moving an auxiliary build platform disposed in the vat to a position adjacent the transparent bottom surface, and subjecting a selected region of the volume of photopolymer resin interposed between the auxiliary build platform and the transparent bottom surface to the radiation source to construct a roof section of the channel, then stopping the step of subjecting and moving the auxiliary build platform away from the roof section that remains on the transparent bottom surface; and
moving the channel floor and channel side walls, which are attached to the main build platform, over and adjacent to the roof section so that the channel side walls that are attached to the main build platform are aligned with the roof section, and subjecting a selective region of the volume of the photopolymer resin to the radiation source to cure the photopolymer resin between the roof section and the channel side walls to thereby bond the channel side walls and roof together to form the hollow channel, wherein the hollow channel has a width as defined along an x-axis between the opposed channel side walls and a height as defined along a z-axis between the floor and roof.

2. The method as recited in claim 1, wherein the main build platform is configured to move vertically in the vat, and wherein the auxiliary build platform is configured to move horizontally and vertically in the vat.

3. The method as recited in claim 1 wherein, during the step of moving the auxiliary build platform to the position adjacent the transparent bottom surface, the auxiliary build platform moves horizontally in the vat beneath the main build platform.

4. The method as recited in claim 1 wherein, during the step of constructing the roof section, the auxiliary build platform is moved vertically away from the transparent bottom surface while a region of the photopolymer resin interposed therebetween is subjected to the radiation source.

5. The method as recited in claim 1 wherein, during the step of subjecting a region of the volume of photopolymer resin to construct the roof section, the auxiliary build platform blocks radiation from the radiation source from passing to the main build platform.

6. The method as recited in claim 1 wherein, during the step of subjecting to build the channel floor and wall sections, a mask image is used to pattern radiation passing from the radiation source to the transparent bottom surface and into the vat.

7. The method as recited in claim 1 wherein, during the step of subjecting to build the roof section of the channel, a mask image is used to pattern radiation passing from the radiation source to the transparent bottom surface and into the vat.

8. The method as recited in claim 7, wherein the mask image is a grayscale mask image.

9. The method as recited in claim 1, wherein the radiation source emits radiation having a wavelength of approximately 405 nm.

10. The method as recited in claim 1, wherein the hollow channel has a channel height of about 100 μm or less.

11. The method as recited in claim 10, wherein the hollow channel has a channel height of from about 10 to 100 μm.

12. The method as recited in claim 1, wherein the hollow channel has a channel height of about 10 μm or less.

13. The method as recited in claim 1, wherein the comprising the hollow channel is a microfluidic device.

14. A 3D microfluidic channel manufacturing device comprising: a main build platform and an auxiliary build platform, for printing microfluidic channels in a 3D printed product.

15. A 3D printing apparatus for constructing a device comprising:
a vat that accommodates a volume of photopolymer resin therein, the vat having a transparent bottom surface;
a radiation source positioned to direct radiation through the transparent bottom surface of the vat and into the vat;
a main build platform configured to move vertically in the vat upwardly and downwardly relative to the transparent bottom surface;
an auxiliary build platform configured to move vertically and horizontally in the vat; and
a controller for controlling movement of the main build platform, movement of the auxiliary build platform, and operating the radiation source for constructing a device by the 3D printing apparatus.

16. The 3D printing apparatus as recited in claim 15, wherein the auxiliary build platform is configured to move horizontally and vertically in the vat when the main build platform is raised a distance above the transparent bottom surface.

17. The 3D printing apparatus as recited in claim 15, wherein the transparent bottom surface of the vat has a bonding force with a cured photopolymer resin that is greater than a bonding force between a surface of the auxiliary build platform and the cured photopolymer resin.

18. The 3D printing apparatus as recited in claim 17, wherein the transparent bottom surface of the vat comprises a coating of fluorinated ethylene propylene, and wherein the surface of the auxiliary build platform comprises a coating of polydimethylsiloxane.

19. The 3D printing apparatus as recited in claim 15, wherein the radiation source emits radiation having a wavelength of approximately 405 nm.

20. The 3D printing apparatus as recited in claim 19, wherein the radiation source is a digital light processor, and wherein the radiation source is configured to use mask images to pattern the radiation directed into the vat for curing selected regions of the photopolymer resin.

21. A device constructed by the 3D printing apparatus as recited in claim 19, wherein the device comprises a hollow channel having a channel height as measured along a z-axis between a channel floor and channel roof of 100 μm or less.

22. The device as recited in claim 21, wherein the channel height is from about 10 to 100 μm.

23. The device as recited in claim 21, wherein the channel height is 10 μm or less.

24. The device of claim 15, wherein the vat is a first vat, and the auxiliary build platform is a first auxiliary build platform, the device further comprising:
a second vat having a resin differing from the photopolymer resin in the first vat; and
a second auxiliary build platform; wherein the device constructed by the 3D printing apparatus comprises at least two different materials.

25. A 3D printed product comprising: a first portion printed at a first time, a second portion printed at a second time, and a third portion printed at a third time, wherein the first time precedes the second time, which precedes the third time, but wherein the third portion is at least partially interposed between the first and second portions.

26. A method of printing a 3D printed product comprising printing a first layer of the product and printing a second layer of the product that for a time is not attached to the first layer of the product, then bringing the first layer and the second layer in proximity to each other and printing a portion of the product that binds the first layer and the second layer together.

27. A 3D printed microparticle sorting device created through use of a main build platform and an auxiliary build platform, the microparticle sorting device comprising:
a mixed particle input port for receiving a stream containing particles of different sizes;
an inlet channel;
a first microchannel particle filter, the first microchannel particle filter comprising a first microchannel that is smaller than the inlet channel for blocking particles that will not fit through the first microchannel;
a second microchannel particle filter, the second microchannel particle filter comprising a second microchannel that is smaller than the first microchannel for blocking particles that will not fit through the second microchannel;
a flow through output port for providing flow through the first microchannel and the second microchannel in series; and
a first sorted outlet port and second sorted outlet port corresponding respectively to the first microchannel particle filter and the second microchannel particle filter, for outputting particles sorted by size.
